(19) United States
(12) Patent Application Publication
(10) Pub. No.: US 2007/0024013 A1
(43) Pub. Date: Feb. 1, 2007

(54) Chuck

(76) Inventors: Udo Hauptmann, Landsberg (DE); Helmut Specht, Bad Woerishofen (DE); Alexander Loeffler, Kaufering (DE)

Correspondence Address: ABELMAN, FRAYNE & SCHWAB, 666 THIRD AVENUE, 10TH FLOOR, NEW YORK, NY, 10017, US

(21) Appl. No.: 11/496,084

(22) Filed: Jul. 27, 2006

(30) Foreign Application Priority Data
Jul. 28, 2005 (DE) 10 2005 000 097.5

(51) Int. Cl. B23B 31/16

(52) U.S. Cl. 279/75

(57) ABSTRACT

A chuck for a percussively driven working tool includes at least one radially displaceable, locking member (3) and a locking element (5, 6) for blocking radial displacement the at least one locking member outwardly. The locking member has a locking surface (4) located radially adjacent to the at least one locking member (3) and formed as a radially damping surface.

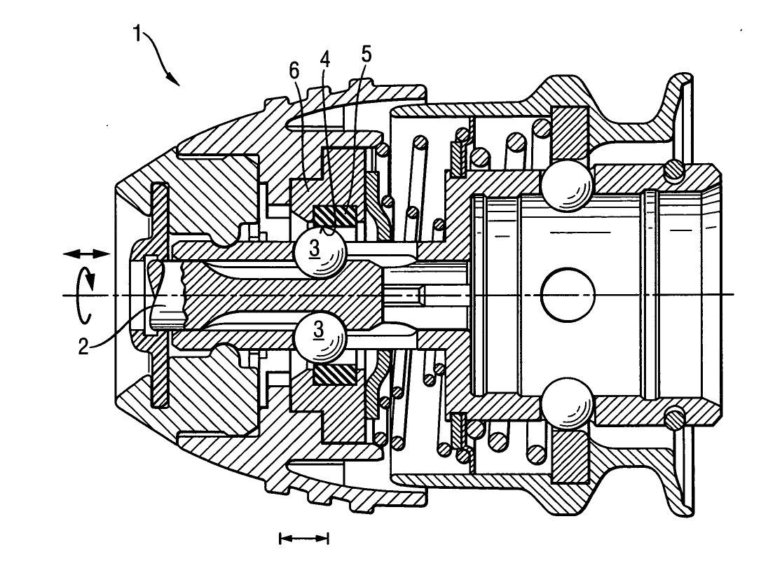

### BACKGROUND OF THE INVENTION

1. Field of the Invention

The present invention relates to a chuck for a mechanized, at least partially percussively driven working tool such as chisel or percussion drill with a radially displaceable locking member.

2. Description of the Prior Art

Chucks as described above have a radially displaceable locking member for radiallly engaging in a locking groove of a working tool shank, and locking means that blocks the displacement of the locking member radially outwardly.

Generally, in connection with the use of the chucks in power hand-held tools, within the chuck, high-impact stresses are produced as a result of which separate parts such as locking members are subjected to complex vibrations that can lead to their wear and fatigue.

As disclosed in U.S. Pat. No. 6,241,026, German publication DE 440 56 97, and U.S. publication US 2003/089509, such chucks include radially displaceable locking members and a locking ring that blocks the radial displacement of the locking members outwardly and is formed of two parts which are made of different materials and are arranged axially relative to each other.

German publication DE 195 36 154 discloses a chuck having a radially displaceable locking member, a locking ring for blocking the radial displacement of the locking member outwardly, and a separate damping ring, which is axially spaced from the locking ring and is formed of rubber, for preventing damage of an actuation collar from a transmitted impact or shock load.

German publication DE 102 43 288 discloses a chuck in which a rubber collar, which serves as a seal, forms a radially displaceable inner part of a two-part locking sleeve formed of different materials and serving for locking the locking member. The locking sleeve is axially displaceable for locking the locking member.

Also known is the damping action of materials with a substantially imaginary component of a complex modulus of elasticity that is determined for plastic materials approximately by a temperature- and frequency-dependent WLF (Williams, Landel, and Ferry) equation which describes the dissipating loss component during molecular relaxation processes.

An object of the invention is to provide a vibration-resistant chuck and, in particular, with respect to the locking member.

### SUMMARY OF THE INVENTION

This an other objects of the present invention which will become apparent hereinafter are achieved with a chuck for a percussively driven working tool and that includes at least one, radially displaceable, locking member, and locking means for blocking radial displacement the at least one locking member outwardly and having a locking surface located radially adjacent to the at least one locking member and formed as a radially damping surface.

The radially damping locking surface optimally suppresses the generated vibrations of the locking member because the main oscillation degree of freedom of the locking member is suppressed.

Advantageously, the locking surface is formed of a material that has a maximum of an imaginary component of a complex modulus of elasticity in a temperature range between 0C and 1 00° C and in a frequency range between 1 Hz and 100 Hz.

Thereby, with this material, an optimal damping in the region in question is achieved.

Advantageously, the locking surface is formed of a radially elastic material, advantageously, of an elastomer such as rubber or silicone resin. Thereby, even with strong radial oscillations, the locking member(s) are in a damping contact with the locking means.

Advantageously, the locking surface is softer than the locking member and, advantageously, is made of a material with a Shore A hardness from 80 up to 95. The locking member becomes thereby embedded in the in the locking means over a large damping contact surface in accordance with the Hertzian loading.

Advantageously, the locking means is rotationally symmetrical and, advantageously, is formed as a sleeve-shaped or annular ring-shaped element. The locking forces act thereby as annular forces.

Advantageously, the locking means is formed of two parts made of different materials, with the radially inner part forming the locking surface. The inner part is optimized separately with respect to damping.

Advantageously, the radial thickness of the inner part amounts to between one-fifth and a single of a radial extent of the locking member. Thereby, a satisfactory deep damping embedding of the locking member in the inner part is possible.

Advantageously, the inner part is formed as a damping ring, whereby the locking forces are applied as annular forces.

Advantageously, the outer part of the locking means is formed of a material having high strength, rigidity, and toughness.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS:

In the drawing:

A single Figure shows a longitudinal cross-sectional view of a chuck according to the present invention.

### DETAILED DESCRIPTION OF THE PREFERRED EMBODIMENTS

A chuck 1 according to the present invention, which is shown in the drawing, is designed for receiving a shank 2, shown only partially, of a percussively driven working tool. The chuck 1 has two radially displaceable locking members 3 in the form of balls. An approximately circular locking element 5-6, which is manually axially displaceable from outside, blocks radial displacement of the locking balls outwardly and has a locking surface 43 which is located radially adjacent to the locking members 3. The locking element 5-6 is formed of two parts made of different materials. The inner part 5 forms a locking surface 4. The outer, axially displaceable part 6 is made of metal. The radial thickness of the damping ring, which is formed of elastic silicone resin with Shore A hardness of 90, with a maximum of loss modulus at 50° and 10 Hz, amounting to a third of a radial extent of the locking balls.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A chuck for a percussively driven working tool, comprising at least one, radially displaceable, locking member (3); and locking means (5, 6) for blocking radial displacement of the at least one locking member (3) outwardly and having a locking surface (4) located radially adjacent to the at least one locking member (3) and formed as a radially damping surface.

2. A chuck according to claim 1, wherein the locking surface (4) is formed of a material that has a maximum of an imaginary component of a complex modulus of elasticity in a temperature range between 0° and 100° and in a frequency range between 1 Hz and 100 Hz.

3. A chuck according to claim 1, wherein the locking surface (4) is formed as a radially elastic surface.

4. A chuck according to claim 1, wherein the locking surface (4) is softer than the locking member (3).

5. A chuck according to claim 1, wherein the locking means (5, 6) is formed rotationally symmetrically.

6. A chuck according to claim 1, wherein the locking means (5, 6) is formed of two parts made of different materials, and wherein a radially inner part (5) forms the locking surface (4).

7. A chuck according to claim 6, wherein a radial thickness of the inner part (5) amounts to between one fifth and single of a radial extent of the locking member (3).

8. A chuck according to claim 6, wherein the inner part (5) is formed as a damping ring.

9. A chuck according to claim 6, wherein an outer part (6) of the locking means (5, 6) is formed of a material having high strength, rigidity, and toughness.
